(19) United States
(12) Patent Application Publication
(10) Pub. No.: US 2002/0002505 A1
(43) Pub. Date: Jan. 3, 2002

(54) Preparing method for delivery request records

(76) Inventor: Takao Kojima, Osaka-shi (JP)

Correspondence Address: Joerg-Uwe Szipl, Griffin & Szipl, P.C., Suite PH-1, 2300 Ninth Street, South, Arlington, VA, 22204-2320, US

(21) Appl. No.: 09/884,935

(22) Filed: Jun. 21, 2001

(30) Foreign Application Priority Data
Jun. 28, 2000 (JP) 2000-193663

(51) Int. Cl. G06F 17/60

(52) U.S. Cl. 705/26; 705/1

(57) ABSTRACT

The invention provides a preparing method for delivery request records by which delivery is possible among an e-mail companion even though a sender does not know a receiver's address, wherein, when a web server computer of a delivery consignee accepts a delivery request from a sender or receiver via a communication terminal (10a), the computer sets one request record consisting of an appropriate number of necessary and reference items (12), and automatically outputs a serial number of the parcel as a parcel ID item, and both of the sender and the receiver input data (10b, 16) via their communication terminals by using said serial number as the ID key code to fill up the necessary items, whereby the delivery request record is prepared. Based on this request record, parcel collection and/or delivery are carried out.

### BACKGROUND OF THE INVENTION

1. Field of the Invention

The present invention relates to a delivery business, in particular, a preparing method for delivery request records (bill) that is carried out before the delivery work.

2. Description of the Related Arts

A sender brings a parcel to a branch office or agent of a delivery consignee, enters an accepted date, his/her (sender's) address, name, and telephone number, a receiver's address, name, and telephone number, contents of the parcel, and delivery desired time zone in a request bill, and the branch officer or agent checks whether or not there are no omissions in the bill, and charges the sender for the delivery.

Or, the delivery consignee visits a sender of, for example, a mail-order business, collects parcels, and at the same time, receives a request bill in which the abovementioned items have been entered, and then and there the delivery charge is paid or to be paid later, and thereafter, the delivery work is carried out.

Recently, due to fusion of computers and communication, businesses using communication terminals and the Internet have received much attention. Furthermore, portable phones have rapidly spread. A portable phone is used as a communication terminal and connected to a web server computer, whereby an access to a website in the Internet can be made.

Particularly, exchange of e-mails has become to be carried out by portable phones as well as personal computers, and has rapidly spread.

Exchange of e-mails has become popular among the younger generation because, generally, even though a user does not know the face and identity of the opposite person, if the user does not mind these and his/her matter of concern matches with the opposite person's, exchange of e-mails are easily and comfortably carried out between them, and the response is quick.

There is a case where it is desired to deliver a parcel of materiality such as a present among an e-mail companion. In such a case, a sender does not know the resident address of a receiver in general although the sender knows the receiver's e-mail address under the circumstances mentioned above.

### SUMMARY OF THE INVENTION

The object of the invention is to provide a preparing method for delivery request records by which, among an e-mail companion, delivery is possible even though a sender does not know a receiver's address.

When a web server computer of a delivery consignee accepts a parcel delivery request from a sender via a communication terminal, the computer sets one request record consisting of an appropriate number of necessary or reference items, automatically outputs a serial number of the request as an ID item of the parcel, and then makes a receiver who can know the serial number to input and designate a delivery destination into said record via a communication terminal by using the serial number as the ID key code, whereby the abovementioned object is achieved.

Or, the sender inputs the receiver's e-mail address into the delivery request record, whereby the web server computer may send an e-mail to the receiver to inform the receiver of at least the parcel serial number and the URL of the server and make him/her to input and designate a delivery destination into said record by using the number and URL as ID key items.

When a web server computer of a delivery consignee accepts a parcel delivery request from a receiver via a communication terminal, the computer sets one request record consisting of an appropriate number of necessary or reference items, automatically outputs a serial number of the request as an ID item of the parcel, makes the receiver to input and designate a delivery destination, and then makes a sender who can know the serial number to input a parcel collecting point into said record via a communication terminal by using the serial number as the ID key code, whereby the same object is achieved.

Or, the receiver inputs the sender's e-mail address into the delivery request record, whereby the web server computer may send an e-mail to the sender to inform the sender of at least the parcel serial number and the URL of the server and make him/her to input a parcel collecting point into said record by using these number and URL as ID key items.

When an exclusive web server computer of a delivery consignee (or by using a web server computer of a provider) accepts a delivery request from a sender or receiver via a communication terminal, the computer sets one request record consisting of an appropriate number of necessary and reference items, automatically outputs a serial number of the request as an ID item of the parcel, and makes the sender and receiver to input data of necessary items that are always necessary to complete the delivery work via their communication terminals by using said serial number as the ID key code, whereby a delivery request record is prepared. Based on this request record, collection and/or delivery of the parcel are carried out.

According to the invention, the delivery destination may be known by only the delivery consignee, the receiver can optionally specify the delivery destination and delivery time, and the address of the sender may also be known by only the delivery consignee. In other words, a delivery request record is prepared by which a delivery is possible even though a sender does not know the address of a receiver.

### BRIEF DESCRIPTION OF THE DRAWINGS

FIG. 1 is an illustration of the initial screen for preparation of a delivery request record.

FIG. 2 is an illustration of the composition of a delivery request record.

FIG. 3 is an illustration of the input guide screen for a delivery request record.

FIG. 4 is an illustration of items to be inputted by a receiver.

FIG. 5 is an entire conception drawing of the delivery system.

### DETAILED DESCRIPTION OF THE PREFERRED EMBODIMENT

A preferred embodiment of the invention is explained based on the drawings.

As communication terminals, exclusive terminals, personal computers, and portable phones can be used although they are not illustrated. The web server computer is not either illustrated. When an URL is specified and an access to a certain file in the web server computer is made from a communication terminal, initial screen 10 is displayed for preparation of delivery request records as illustrated in FIG. 1. Command buttons of delivery request acceptance 10a, record input 10b, and cancel 10c are arranged on the screen.

Generally, a so-called website in the Internet that can be connected by a public telephone line is used, and in this case, a database memory storage is used as well as the web server computer, and record files are prepared in advance herein. For example, as mentioned above, when an URL is specified in the screen of browser software such that the Netscape, the specified website can be accessed. Therefore, the screen 10 may be an example of the initial screen of a website.

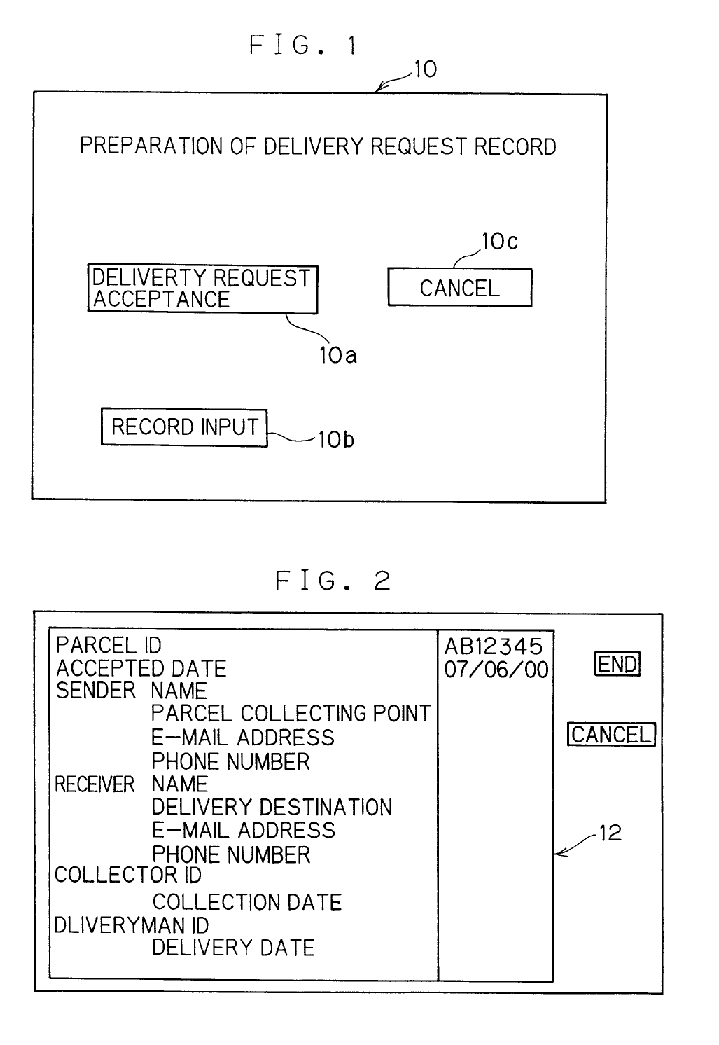

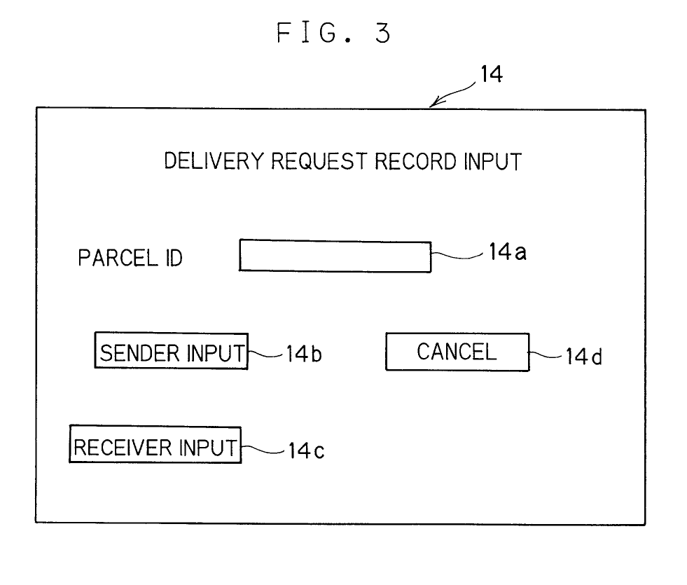

Then, when the delivery request acceptance button 10a is clicked, a part of a screen shown in FIG. 2 appears, and when the record input button 10b is clicked, a screen shown in FIG. 3 appears. The cancel button 10c is clicked when the user changes his/her mind and cancels use of this system, and these buttons also have the same functions in the screens described below.

FIG. 2 shows an example of the arrangement of an appropriate number of necessary or reference items of one request record, a part of the items is displayed as necessary, and input boxes are arranged on the side of the items, however, the parcel ID item is automatically outputted by a counter inside the web server computer. The accepted date is also automatically displayed by the software.

It is not necessary to input all the illustrated items. Items to be displayed on the screen are determined in advance depending on the accessing user who is a sender or receiver.

The parcel collecting point is a necessary item. It is not necessary to output the serial number of the parcel ID item at the same time of display of the screen. The number may be outputted when the necessary item such as the parcel collecting point is inputted. If a sender enters his/her e-mail address, after completing the delivery to the receiver, the sender may be provided with a service whereby he/her receives the delivery information. Likewise, if the sender's telephone number is inputted, in the case where a trouble occurs later, this number becomes a means to contact the sender. Therefore, these items are reference items or necessary items in order to achieve the delivery work.

When appropriate items of FIG. 2 are displayed for the sender, and the sender finishes inputting, the sender presses the end button. Thereby, the sender can obtain a hardcopy and check the inputted items as well as the parcel ID number.

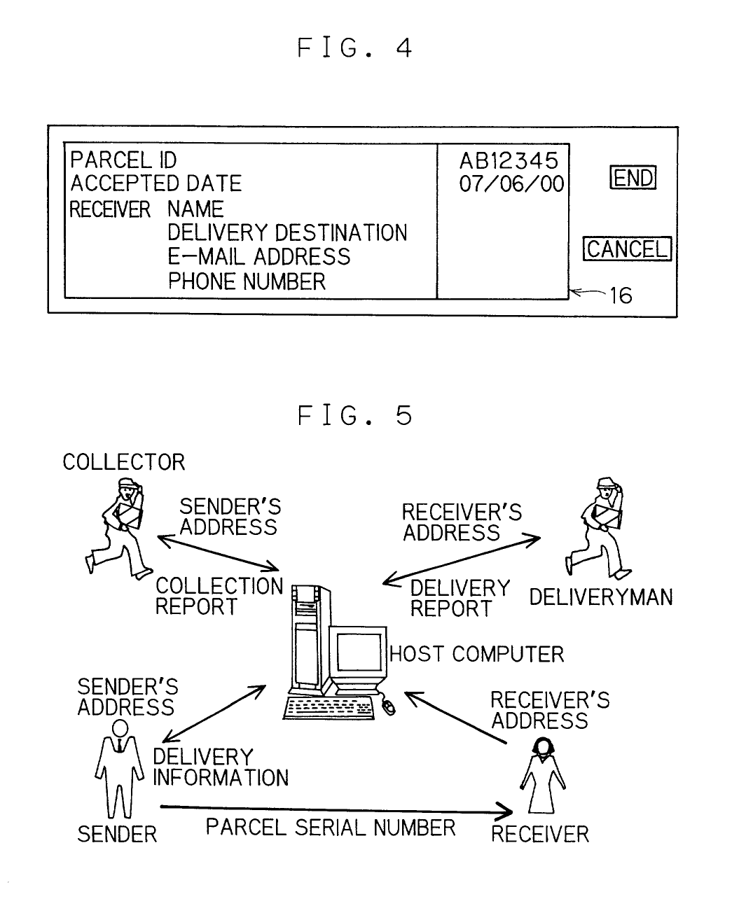

Thereafter, the sender informs the receiver by phonecall or e-mail of the parcel ID and the URL when the sender has used a website for delivery. The informed receiver accesses the website of the web server computer, and then screen 14 illustrated in FIG. 3 appears. The receiver inputs the informed serial number into parcel ID input field 14a, and then presses the receiver input command button 14c, whereby screen 16 illustrated in FIG. 4 appears, and the receiver inputs at least a delivery destination that is a necessary item. When completing inputting, the receiver can obtain the same hardcopy.

If the sender inputs the receiver's e-mail address when or after requesting the delivery, a function to send an e-mail to the receiver is added to the web server computer. Thereby, the parcel ID number is written and the URL address are attached in the mail to be received by the receiver, and the receiver can access the screen 14 shown in FIG. 3 when opening the mail, and input necessary items.

In the case where a terminal of the agent of the delivery consignee is used to request a delivery, generally, the parcel is collected at the agent and at the same time, the charge for the delivery is charged. In the case where the sender's own terminal is used, there are three methods. In the first method, parcel collection is carried out after the sender inputs the parcel collecting point or address. On the other hand, in the second method, parcel collection is carried out after the sender inputs a parcel collecting point or address and the receiver inputs and designates a delivery destination. In the second method, the parcel can be delivered immediately after being collected.

In the third method, the sender acquires only the parcel ID number when he/she requests a delivery, and after the receiver inputs and designates a delivery destination, the receiver informs the sender that he/she has inputted the destination, and then the sender inputs a parcel collecting point, whereby parcel collection is carried out. In this case, as with the second method, the parcel can be delivered immediately after being collected. The web server computer watches inputting of necessary items, and selects any one method in advance.

If there is a continuous business relationship between the receiver and the delivery consignee, the serial number of the parcel ID number and the designated delivery destination may be determined to be fixed. In this case, the parcel ID number is informed from the receiver to the sender. Thereby, the sender inputs a parcel collecting point, parcel collection is carried out, and immediately after parcel collection, the parcel can be delivered.

For certain reasons, there is a case where the receiver makes a delivery request and obtains a new parcel ID number, and in this case, the procedures similar to the procedures mentioned above are carried out. Thus, the parcel ID number is informed from a sender to a receiver or is informed vice versa.

If a deliveryman also brings a communication terminal that can be connected to the web server computer, he/she is informed of the parcel ID number from the web server computer when the delivery becomes possible, and can know the destination based on the ID number. When the deliveryman completes the delivery work, he/she inputs this information into the item in the same record, and then informs the sender that the delivery has been completed. If the deliveryman brings a communication terminal, the delivery work can be efficiently carried out. FIG. 5 is an entire conception drawing of the delivery system using the invention.

In the case of mail-order business, the sender is substituted by a distributor, and the receiver is substituted by a customer or a third party. The collection of the delivery charge or payment for goods is carried out by means of payment by the sender (prepayment), payment by the receiver (cash on delivery) or remittance after delivery.

What is claimed is:

1. A preparing method for delivery request records, wherein, when a web server computer of a delivery consignee accepts a delivery request from a sender via a communication terminal, the computer sets one request record consisting of an appropriate number of necessary and reference items, automatically output a serial number of the parcel as a parcel ID item, and makes a receiver who can know the serial number to input and designate a delivery destination into said record by using the serial number as the ID key code.

2. A preparing method for delivery request records as set forth in claim 1, wherein the sender is made to input the receiver's e-mail address into the delivery request record, whereby the web server computer sends an e-mail to the receiver to inform him/her of at least the serial number of the parcel ID code and the server's URL.

3. A preparing method for delivery request records, wherein, when a web server computer of a delivery consignee accepts a delivery request from a receiver via a communication terminal, the computer sets one request record consisting of an appropriate number of necessary and reference items, automatically outputs a serial number of the parcel as an ID item of the parcel, makes the receiver to input and designate a delivery destination, and makes a sender who can know the serial number to input a parcel collecting point into said record by using the serial number as the ID key code.

4. A preparing method for delivery request records as set forth in claim 3, wherein the web server computer makes the receiver to input the sender's e-mail address into the delivery request record, whereby the computer sends an e-mail to the sender and informs of at least the serial number of the parcel and the server's URL.

5. A web server computer to be used to carry out the method of claim 1 or 3.

6. A communication terminal of an agent of a delivery consignee, which is used to carry out the method of claim 1 or 3.
